(19) United States
(12) Patent Application Publication
(10) Pub. No.: US 2025/0234157 A1
(43) Pub. Date: Jul. 17, 2025

(54) SYSTEM AND METHOD FOR ESTIMATING A DIRECTION FROM ONE UE TO ANOTHER USING SIDELINK

(71) Applicant: Sony Group Corporation, Tokyo (JP)

(72) Inventors: Yujie ZHANG, Lund (SE); Basuki PRIYANTO, Lund (SE); Jose FLORDELIS, Lund (SE); Anders BERGGREN, Lund (SE); Johan HILL, Lund (SE)

(21) Appl. No.: 18/854,612

(22) PCT Filed: Apr. 28, 2023
(86) PCT No.: PCT/EP2023/061338

§ 371 Date: Oct. 7, 2024

(30) Foreign Application Priority Data
Apr. 29, 2022 (SE) 2250519-2

(51) Int. Cl. H04W 4/02; H04W 92/18

(52) U.S. Cl. CPC H04W 4/025; H04W 4/023; H04W 92/18

(57) ABSTRACT

A method for estimating a direction from a first user equipment—UE—to a second UE, the first UE and the second UE being connectable to a communications network, comprises obtaining, based on a first sidelink position determination signal—SL-PDS—communicated on a sidelink of the communications network between the first UE and the second UE, a first estimated distance between the first UE and the second UE, obtaining, based on a second position determination signal—PDS—communicated between the first UE and a first assist node associated with the communications network, a second estimated distance between the first UE and the first assist node, obtaining, based on a third PDS communicated between the second UE and the first assist node, a third estimated distance between the second UE and the first assist node; and estimating, the direction from the first UE to the second UE based on the first, second and third estimated distance.

### TECHNICAL FIELD

The invention generally relates to estimating a direction from one user equipment (UE) to another relying at least partially on direct communication. In some embodiments of the present invention, this direct communication occurs over the PC5 interface.

### BACKGROUND

Modern UEs are typically unable to estimate distance and direction of another UE relative to their own position. However, as e.g. discussed in RP-213588: “Revised SID on Study on expanded and improved NR positioning”, being able to provide at least a rough estimate of the relative position of UEs with regard to one another would be beneficial given the multitude of functionalities modern day UEs are expected to perform. One way to enable distance estimations may be to exchange reference signals via direct communication between UEs. One exemplary mode of direct communication is Sidelink communication via the PC5 interface, as e.g. defined in 3GPP technical specifications 38.211, Chapter 8, 38.212, Chapter 8, 38.213, Chapter 16 and 38.214 Chapter 8 for RAN1 (all RAN1 technical specifications version 17.1.0) and 38.331, Chapter 5.8 for RAN2 (version 17.0.0).

FIG. 1 illustrates a two-dimensional result of the distance estimation based on the exchange of reference signals between a UE 101 and a UE 102. As can be seen, UE 101 can estimate the relative distance to UE 102 based on this exchange of reference signals. However, UE 101 cannot estimate the direction from itself to UE 102. From the point of view of UE 101, UE 102 may be positioned anywhere on a circle around UE 101 with a radius of the estimated distance between UE 101 and UE 102. This is indicated by three exemplary instances of UE 102 shown in FIG. 1 as boxes with a dotted outline. Any one of these three exemplary instances can be the actual position of UE 102 relative to UE 101. However, UE 101 cannot identify the actual relative position of UE 102. Since FIG. 1 illustrates a two-dimensional result of the current estimation of the relative position, it should be understood that in fact, when taking into account the third dimension, UE 102 may be positioned anywhere on a multitude of circles centered on UE 101, one of which being shown in FIG. 1A. Thus, UE 102 may be positioned anywhere on the surface of a sphere with a radius corresponding to the estimated distance from UE 101 to UE 102.

UEs may be incorporated into or may themselves be cellphones, terminals, loT devices, extended sensors or vehicles, among others. In particular, in the context of vehicles, e.g. for the purpose of vehicle platooning, advanced driving and remote driving, it would be beneficial, if UEs were also aware of the relative direction in addition to the relative distance, when estimating their relative positions to one another. Of course, the benefit of being aware of the relative direction is not limited to vehicles.

In addition to not being able to estimate a direction, current UEs are only capable of estimating the distance between them if direct communication via a line of sight (LOS) link is available.

Therefore, the estimation of their relative position to one another is limited for current UEs to distance estimation based on an LOS link.

Therefore, it is an objective of the present invention to improve the way UEs estimate their relative positions to one another so that they are aware of their relative direction without having to rely on an LOS link.

### SUMMARY OF THE INVENTION

To achieve this objective, the present invention provides a method for estimating a direction from a first UE to a second UE, the first UE and the second UE being connectable to a communications network. The method comprises the steps of: obtaining, based on a first sidelink position determination signal-SL-PDS-communicated on a sidelink of the communications network between the first UE and the second UE, a first estimated distance between the first UE and the second UE, obtaining, based on a second position determination signal-PDS-communicated between the first UE and a first assist node associated with the communications network, a second estimated distance between the first UE and the first assist node, obtaining, based on a third PDS communicated between the second UE and the first assist node, a third estimated distance between the second UE and the first assist node and estimating, the direction from the first UE to the second UE based on the first, second and third estimated distance.

Further, the present invention provides a computer readable medium, which includes instructions causing one or more processors of at least one of a first UE, a second UE, a first and a location control node to estimate a direction from the first UE to the second UE, the first UE and the second UE being connectable to a communications network, by performing the steps of obtaining, based on a first sidelink position determination signal-SL-PDS-communicated on a sidelink of the communications network between the first UE and the second UE, a first estimated distance between the first UE and the second UE, obtaining, based on a second position determination signal-PDS-communicated between the first UE and the first assist node associated with the communications network, a second estimated distance between the first UE and the first assist node, obtaining, based on a third PDS communicated between the second UE and the first assist node, a third estimated distance between the second UE and the first assist node and estimating, the direction from the first UE to the second UE based on the first, second and third estimated distance.

### BRIEF DESCRIPTION OF THE DRAWINGS

Embodiments of the present invention will be described with reference to the following appended drawings, in which like reference signs refer to like elements.

FIG. 1 is an example of the estimation of the relevant position by a UE according to the prior art.

FIG. 2 is an example of direct communication between UEs as well as of a communications network, which respectively enable, alone or in combination, the estimation of a direction from a first UE to a second UE.

FIG. 3 is an example of a base station according to embodiments of the present invention.

FIG. 4 is an example of a UE according to embodiments of the present invention.

FIG. 5 is an example of a location monitoring function according to embodiments of the present invention.

FIGS. 6A to 6C illustrate a method for estimating a direction from a first UE to a second UE according to embodiments of the present invention.

FIGS. 7A to 7C provide examples of how the method of FIGS. 6A to 6C may be used according to embodiments of the present invention.

FIGS. 8A and 8B provide examples of how the method of FIGS. 6A to 6C may be used if an LOS link is not available for at least some UEs or nodes, respectively, according to embodiments of the present invention.

FIGS. 9A and 9B illustrate which UEs or nodes, respectively, may perform certain steps of the method of FIGS. 6A to 6C according to embodiments of the present invention.

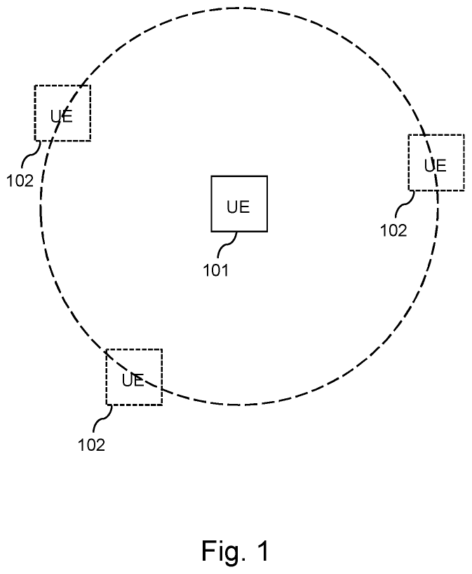

It should be understood, that these drawings are in no way meant to limit the disclosure of the present invention. Rather, these drawings are provided to assist in understanding the invention. The person skilled in the art will readily understand that aspects of the present invention shown in one drawing may be combined with aspects in another drawing or may be omitted without departing from the scope of the present invention.

### DETAILED DESCRIPTION

The present disclosure generally provides a method for estimating a direction from a first UE to a second UE. To estimate the direction, an assist node is enlisted in order to obtain three estimated distances, i.e. the distances from the first UE to the second UE and to the assist node as well as from the second UE to the assist node. The assist node may be a UE like the first and the second UEs or may be a node of a communications network. With the three estimated distances, the direction from the first UE to the second UE can be estimated. In the case of the first estimated distance, i.e. the distance from the first UE to the second UE, this distance is obtained based on a first sidelink position determination signal (SL-PDS), i.e. a signal enabling the determination of a position of the second UE relative to the first UE using direct communication between them, such as communication over the PC5 interface. The second and third estimated distances, i.e. the estimated distances between the first UE and the assist node and between the second UE and the assist node, respectively, are obtained based on a second and a third PDS. Both the first and the second PDS are each a signal enabling the determination of the relative positions of the respective entities to one another. The second and the third PDS may either be communicated via a communications network or via direct communication like the first SL-PDS. In the latter case, the second and the third PDS may also be referred to as second and third SL-PDS.

In summary, the method for estimating a direction from the first UE to the second UE is generally based on enlisting an assist node and estimating the distances between these three entities based on signaling between them, wherein at least the signaling between the first UE and the second UE is based on direct communication. In cases where the assist node is also a UE, the method may entirely rely on direct communication and may thus be independent of a communications network. By enlisting an assist node to estimate the direction, the method can use a specific assist node having an LOS link with the first UE and the second UE. Furthermore, should the first UE not have an LOS link with the second UE, one or more additional assist nodes can be enlisted so that at least three estimated distances based on an LOS link can be obtained.

The general concept of the method for estimating a direction from the first UE to the second UE will now be discussed in detail with reference to the drawings.

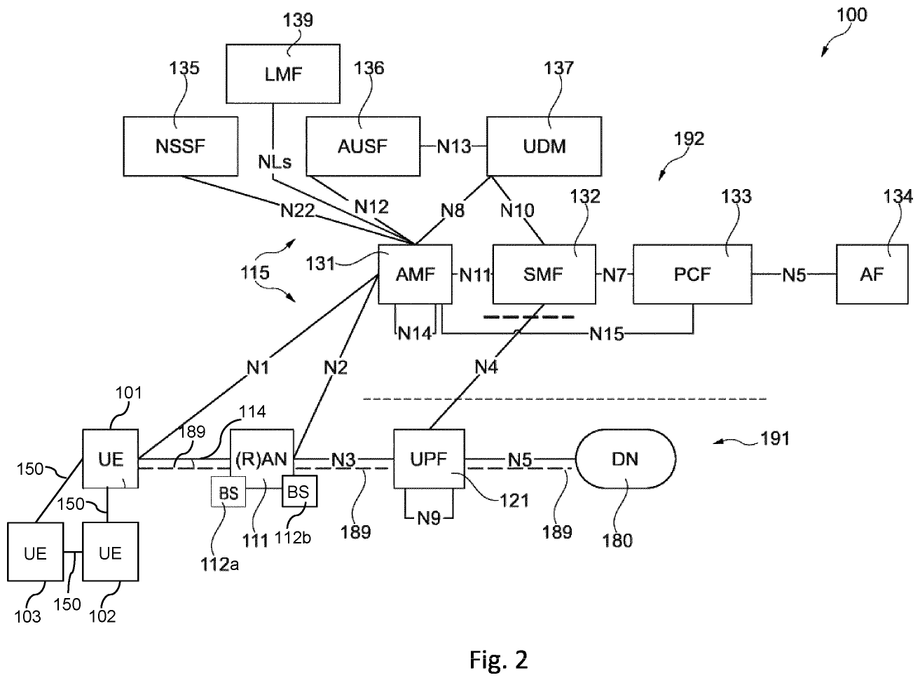

FIG. 2 schematically illustrates a cellular communications network 100. The example of FIG. 2 illustrates the communications network 100 according to the 3GPP 5G architecture. Details of the 3GPP 5G architecture are described in 3GPP TS 23.501, version 17.4.0. While FIG. 2 and further parts of the following description illustrate techniques in the 3GPP 5G framework of a cellular network, similar techniques may be readily applied to other communication networks. Examples include e.g., an IEEE Wi-Fi technology.

In the scenario of FIG. 2, a first UE 101 is connectable to the cellular communications network 100. Throughout the discussion of the present invention, UE may refer to any kind of user equipment, including but not limited to, a cell phone, an loT device, traffic infrastructure equipment, such as traffic lights or variable message signs (VMS), vehicle communication systems, such as eCall or OnStar®, and autonomous driving systems. In other words, UE may refer to any kind of equipment connectable to a communications network which requires a direction estimation to another UE for some part of its functionality.

The first UE 101 is connectable to the network 100 via a radio access network (RAN) 111, typically formed by one or more base stations (BS), such as BS 112a and 112b (only two BS are illustrated in FIG. 2 for the sake of simplicity; the BSs implement access nodes (AN)). Depending on the standard implemented by communications network 100, a BS may also be referred to as eNB, gNB or transmission and reception point (TRP). A wireless link 114 is established between the RAN 111—specifically between one or more of the BSs 112 of the RAN 111—and the UE 101. The wireless link 114 is defined by one or more OFDM carriers. BS 112a and 112b may also be referred to as assist nodes.

FIG. 2 further illustrates a second UE 102 and an assist UE 103. Both the second UE 102 and the assist UE 103 correspond with regard to their functionality to UE 101. The above discussion of the first UE 101 is therefore applicable to the second UE 102 and the assist UE 103. For the sake of simplicity, the connections of UE 102 and UE 103 to RAN 111 are omitted. Assist UE 103 may also be referred to as an assist node.

The first UE 101, the second UE 102, and the third UE 103 are further connectable with one another to enable direct communication, as indicated by connections 150. Connections 150 may be established over the PC5 interface, i.e. via Sidelink communication, as e.g. defined in 3GPP technical specifications 38.211, Chapter 8, 38.212, Chapter 8, 38.213, Chapter 16 and 38.214 Chapter 8 for RAN1 (all RAN1 technical specifications version 17.1.0) and 38.331, Chapter 5.8 for RAN2 (version 17.0.0). It should be noted that sidelink communication is possible even if none of the UEs 101, 102 and 103 are connected to the communications network 100.

The RAN 111 is connected to a core network (CN) 115. The CN 115 includes a user plane (UP) 191 and a control plane (CP) 192. Application data is typically routed via the UP 191. For this, there is provided a UP function (UPF) 121. The UPF 121 may implement router functionality.

Application data may pass through one or more UPFs 121. In the scenario of FIG. 2, the UPF 121 acts as a gateway towards a data network (DN) 180, e.g., the Internet or a Local Area Network. Application data can be communicated between the UE 101 and one or more servers on the DN 180.

The communications network 100 also includes an Access and Mobility Management Function (AMF) 131; a Session Management Function (SMF) 132; a Policy Control Function (PCF) 133; an Application Function (AF) 134; a Network Slice Selection Function (NSSF) 134; an Authentication Server Function (AUSF) 136; a Unified Data Management (UDM) 137; and a Location Management Function (LMF) 139. FIG. 2 also illustrates the protocol reference points N1-N22 between these nodes.

The AMF 131 provides one or more of the following functionalities: registration management; NAS termination; connection management; reachability management; mobility management; access authentication; and access authorization. A data connection 189 is established by the AMF 131 if the first UE 101 operates in a connected mode. Connection 189 may also be established by AMF 131 for second UE 102 and assist UE 103 but is omitted in FIG. 2 for the sake of simplicity.

The SMF 132 provides one or more of the following functionalities: session management including session establishment, modify and release, including bearers set up of UP bearers between the RAN 111 and the UPF 121; selection and control of UPFs; configuring of traffic steering; roaming functionality; termination of at least parts of NAS messages; etc. As such, the AMF 131 and the SMF 132 both implement CP mobility management needed to support a moving UE.

The data connection 189 is established between the first UE 101 via the RAN 111 and the data plane 191 of the CN 115 and towards the DN 180. For example, a connection with the Internet or another packet data network can be established. To establish the data connection 189, it is possible that the first UE 101 performs a random access (RA) procedure, e.g., in response to reception of a paging indicator or paging message and, optionally, a preceding wake up signal (WUS). A server of the DN 180 may host a service for which payload data is communicated via the data connection 189. The data connection 189 may include one or more bearers such as a dedicated bearer or a default bearer. The data connection 189 may be defined on the radio resource control (RRC) layer, e.g., generally Layer 3 of the OSI model of Layer 2.

LMF 139, which may also be referred to as a location control node, handles location service requests. This may include transferring assistance data to the first UE 101 to be positioned to assist with UE-based and/or UE-assisted positioning and/or may include positioning of the first UE 101. See 3GPP TS 38.305, section 5.1, version 17.0.0. For downlink (DL) positioning using PRSs, the LMF 139 may instigate location procedures using a positioning protocol with the first UE 101—e.g. to obtain a location estimate or positioning measurements or to transfer location assistance data to the first UE 101. The location service requests handled by LMF 139 may also include a request to estimate a direction from the first UE 101 to the second 102.

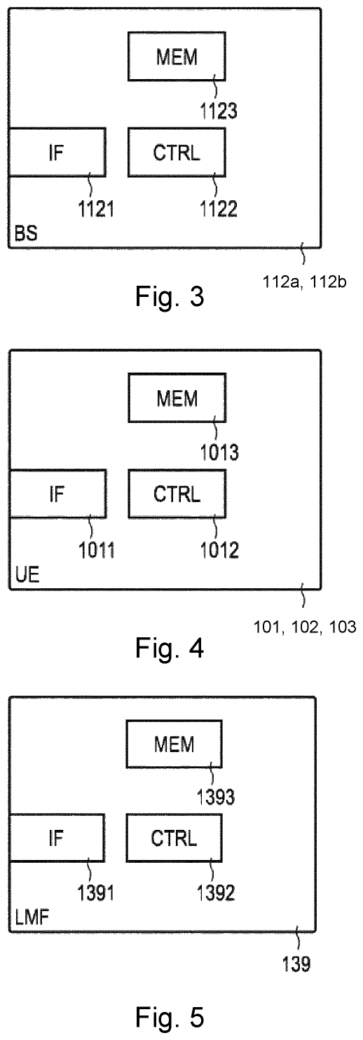

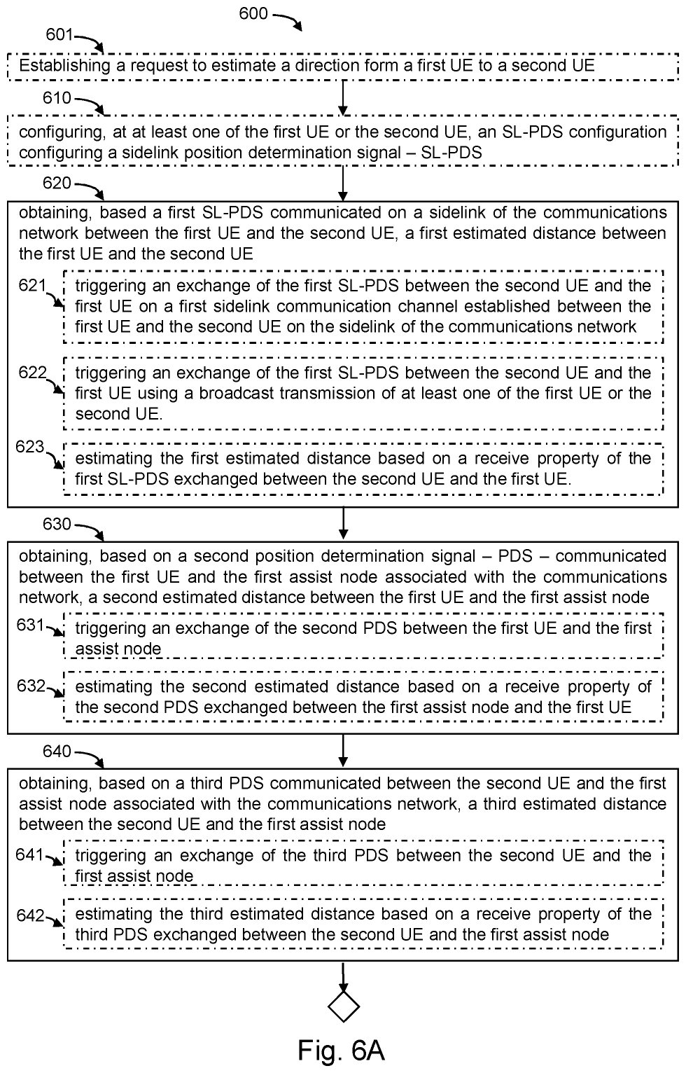

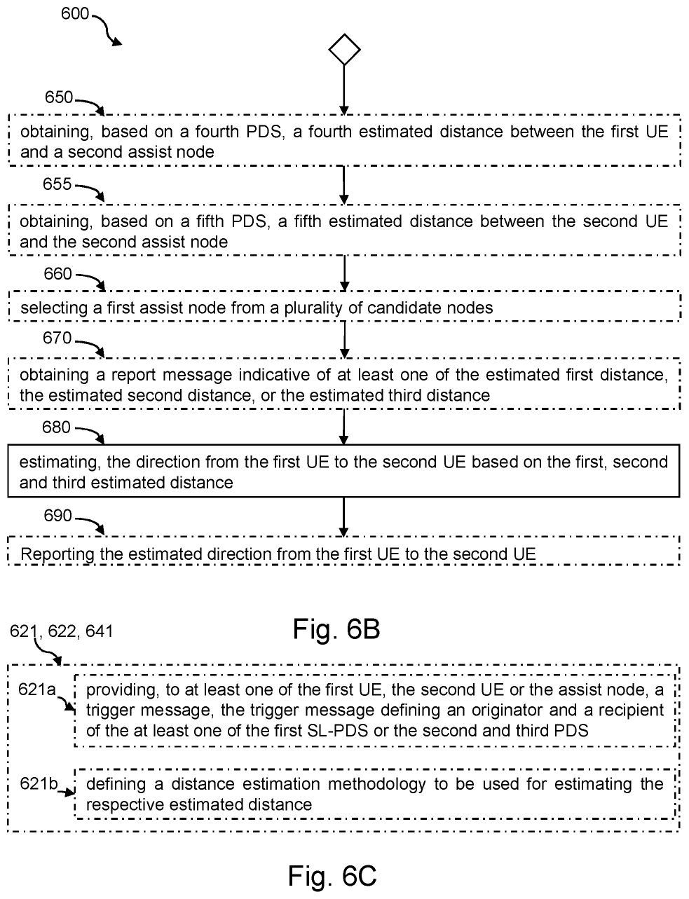

FIG. 3 schematically illustrates BS 112a and 112b. The BS 112 includes an interface 1121. For example, the interface 1121 may include an analog front end and a digital front end. The interface 1121 can support multiple signal designs, e.g., different modulation schemes, coding schemes, modulation numerologies, and/or multiplexing schemes, etc. The BS 112 further includes control circuitry 1122, e.g., implemented by means of one or more processors and software. For example, program code to be executed by the control circuitry 1122 may be stored in a non-volatile memory 1123. In the various examples disclosed herein, various functionality may be implemented by the control circuitry 1122, e.g. estimating a direction from the first UE 101 to the second UE102, as will be discussed with further reference to FIGS. 6A to 6C. For example, in one embodiment the functionality implemented by the control circuitry 1122 may be the functionality of an assist node.

FIG. 4 schematically illustrates first UE 101, second UE 102 and assist UE 103. The UEs includes an interface 1011. For example, the interface 1011 may include an analog front end and a digital front end. The UEs further include control circuitry 1012, e.g., implemented by means of one or more processors and software. The control circuitry 1012 may also be at least partly implemented in hardware. For example, program code to be executed by the control circuitry 1012 may be stored in a non-volatile memory 1013. In the various examples disclosed herein, various functionality may be implemented by the control circuitry 1012. Such functionality may include estimating a direction from the first UE 101 the second UE 102 based on communicating a first SL-PDS, a second PDS and a third PDS via interface 1011.

FIG. 5 schematically illustrates an example LMF 139 as discussed with reference to FIG. 2. The LMF 139 includes an interface 1391 for communicating with other nodes of the CN 115 or with the RAN111 of the cellular network 100. The LMF 139 further includes control circuitry 1392, e.g., implemented by means of one or more processors and software. For example, program code to be executed by the control circuitry 1392 may be stored in a non-volatile memory 1393. In the various examples disclosed herein, various functionality may be implemented by the control circuitry 1392, such as a method for estimating a direction from the first UE 101 to the second UE 102 as will be discussed with reference to FIGS. 6A to 6C.

FIGS. 6A to 6C illustrate a method 600 for estimating a direction from the first UE 101 to the second UE 102. Throughout FIGS. 6A to 6C, steps shown in dashed boxes are used to indicate optional steps. Some of these optional steps, such as steps 621 to 623, are optional parts of a step, such as step 620, as indicated by these steps being shown inside the box of the respective step.

Steps 601 to 690 will be discussed in the order shown in FIGS. 6A to 6C. However, it will be understood by those skilled in the art that this description is in no way meant to imply that the steps need to be performed in this order. Rather, the steps can be performed in any order suitable to estimate the direction from the first UE 101 to the second UE 102. For example, steps 620 to 655 may be performed concurrently, in an inverse order as shown or in a completely different order such as step 640 first, followed by steps 620, 655, 630 and 650. Also, step 660 may for example be performed before steps 620 to 655.

In step 601, the method 600 may establish a request to estimate a direction from the first UE 101 to the second UE 102. The request may be established within the first UE 101, e.g. by another functionality being performed within control circuitry 1012, such as an autonomous driving functionality. The request may be established by the first UE 101 and transmitted to the second UE 102 and/or assist UE 103, either directly or via communications network 100. The request may be established by an entity of the communications network 100, such as LMF 139, in response to a location service request. In some embodiments, the method 600 may skip step 601 and estimate the direction from the first UE 101 to the second UE 102 without establishing a request.

In step 610, the method 600 may configure, at least the first UE 101 or the second UE 102, an SL-PDS configuration configuring a sidelink position determination signal-SL-PDS.

SL-PDS in the context of the present application refers to any kind of signal enabling the determination of a position of one UE, such as the second UE 102, relative to another UE, such as first UE 101, using any kind of direct communication between the two UEs. While the description refers to such a signal as SL-PDS, it should be apparent that the name of the signal may be replaced by any other suitable expression, such as sidelink position reference signal (SL-PRS) or sidelink reference signal (SL-RS). Direct communication refers to direct communication between UEs without being routed through the communications network 100. As discussed above, one such type of direct communication is direct communication via the PC5 interface, commonly referred to as Sidelink, and illustrated in FIG. 2 by connections 150. Of course, other types of direct communication may be used instead of or in conjunction with Sidelink communication, such as Bluetooth Low Energy (BLE) or Wi-Fi.

In some embodiments, the SL-PDS configuration may be communicated from an access node of the communications network 100, such as RAN 111, or a location control node, such as LMF 139, to the first UE 101 or the second UE 102. In some embodiments, the SL-PDS configuration may further be communicated form these entities to assist UE 103.

In some embodiments, the SL-PDS configuration may be communicated between first UE 101 and second UE 102 using control signaling on sidelink 150. For example, the SL-PDS configuration may be included in sidelink broadcast control channel (SBCCH) or sidelink control information (SCI) signals.

In some embodiments, the SL-PDS configuration may comprise at least one of a transmission timing of the SL-PDS, a time-frequency resource allocated by communications network 100 to the SL-PDS, a transmit power of the SL-PDS, a beam configuration of the SL-PDS, a sequence design of the SL-PDS, at least one reporting item for reporting an exchange of the SL-PDS between first UE 101 and second UE 102, a point in time at which the first SL-PDS is to be sent, or a time interval within which the first SL-PDS is to be sent. All of these configuration items may enable estimating distances between first UE 101, second UE 102 and an assist node, as will be discussed in the following.

In some embodiments, an SL-PDS configuration may not be necessary as both first UE 101 and second UE 102 are aware of the SL-PDS configuration, e.g. because the SL-PDS-configuration is pre-defined or determined by the UEs based on pre-defined factors, such as mobility of the UEs or characteristics of prior Sidelink communication between the UEs.

In step 620, the method 600 obtains a first estimated distance between first UE 101 and second UE 102 based on a first SL-PDS communicated on a sidelink 150 of the communications network 100.

The first distance may be estimated based on any distance estimation methodology enabling the estimation of a distance based on the exchange of a signal, i.e. in the case of the first estimated distance the first SL-PDS.

In some embodiments, the distance estimation methodology may be a one-way ranging measurement or a round-trip measurement, i.e. the methodology may be based solely on the receipt of the first SL-PDS or may be based on the receipt at the transmitter of the first SL-PDS of an indication of receipt of the first SL-PDS, such as an acknowledge (ACK) signal from the receiver of the first SL-PDS. In some embodiments, the distance estimation methodology may be based on the receipt of the SL-PDS in both directions.

In some embodiments, the distance estimation methodology may be based on measuring one of a signal strength, an angle or a time. Accordingly, the distance may be measured based on the signal strength of the first SL-PDS, an angle, such as the angle-of-arrival (AoA) or the angle-of-departure (AoD) of the first SL-PDS, or a time between transmission and receipt of the first SL-PDS. More precisely, in some embodiments, the measurement may be one of reference signal received power (RSRP), time difference of arrival (TDOA) or time difference between sender and receiver.

In some embodiments, the method 600 may specifically include a step 623, which estimates the first estimated distance based on a receive property of the first SL-PDS exchanged between second UE 102 and first UE 101. Accordingly, the estimation of the first distance may be estimated based on the measurement of a property of the first SL-PDS upon its receipt.

The measured property may be the received signal strength of the first SL-PDS. For example, the SL-PDS may be defined as having a reference signal strength. Accordingly, the distance estimation may be based on the difference between the received signal strength and the reference signal strength. To this end, a transmit power of the SL-PDS may be defined in the SL-PDS configuration.

The measured property may be the propagation time. In case of a one-way ranging measurement, the propagation time corresponds to the time it takes for the first SL-PDS to be received after it has been sent. In case of a round-trip measurement, the propagation time corresponds to the time it takes for the transmitter of the first SL-PDS to receive an ACK message from the receiver of the first SL-PDS. In another example, the round-trip measurement is measured based on the transmission and reception of SL-PDS in both directions. In both cases, the first distance may be estimated based on the elapsed time. To this end, any one of a transmission timing of the SL-PDS, a time-frequency resource allocated to the SL-PDS, a point in time at which the first SL-PDS is to be sent, at least one reporting item for reporting an exchange of the SL-PDS between first UE 101 and second UE 102 and a time interval within which the first SL-PDS is to be sent may be defined in the SL-PDS configuration.

The measured property may be a time stamp indicating a time of transmission of the first SL-PDS or a time stamp indicating receipt of a trigger message at the transmitter of the first SL-PDS. To this end, in embodiments in which first UE 101 and second UE 102 are connected to communications network 100, both UEs may be synchronized to a clock of communications network 100. In embodiments in which first UE 101 and second UE 102 are not connected to communications network 100, both UEs may negotiate or define a synchronized clock via SCI signals or some other control signaling of the sidelink 150.

The measured property may be the AoA of the first SL-PDS. For example, if the interface 1011 of the receiving UE comprises an antenna array, the AoA may be determined based on the difference in the phase received at each element in the antenna array. The measured property may be the angle-of-departure (AoD). For example, if the interface 1011 of the transmitting UE is capable of beam sweeping, the receiving UE can determine the AD based on identifying the strongest beam received at the receiving UE. In either case, the estimated first distance may be derived from the respective angle. This may e.g. be achieved if the AoD or the AoA is known for one node, such as the first assist node, from the point of view of two other nodes, such as first UE 101 and second UE 102. To this end, any one of a beam configuration of the SL-PDS and a sequence design of the SL-PDS may be defined in the SL-PDS configuration.

In some embodiments, the receive property is used at the receiver to estimate the first distance. Therefore, in embodiments in which the first SL-PDS is transmitted from second UE 102 to first UE 101, first UE 101 estimates the first distance. In some embodiments, the receive property is communicated to another entity, e.g. a location control such as LMF 139 of communication network 100, for estimation of the first distance.

In one embodiment, the first SL-PDS is sent from second UE 102 to first UE 101. In one embodiment, the first SL-PDS is sent from first UE 101 to second UE 102. Therefore, either one of first UE 101 and second UE 102 may measure a property of the received first SL-PDS.

In some embodiments, obtaining the first estimated distance may include a step 621 triggering an exchange of the first SL-PDS between second UE 102 and first UE 101 on a first sidelink communications channel established between first UE 101 and second UE 102 on the sidelink 150 of communications network 100. In other words, the exchange of the first SL-PDS may be triggered using sidelink data during sidelink data transmission.

In some embodiments, obtaining the first estimated distance may include a step 622 triggering an exchange of the first SL-PDS between second UE 102 and first UE 101 using a broadcast transmission of at least one of first UE 101 and second UE 102. In other words, one of first UE 101 and second UE 102 may use the sidelink broadcast channel (SL-BCH) to trigger the exchange of the SL-PDS.

In some embodiments, triggering the exchange of the first SL-PDS may define a configuration of the first SL-PDS. To define such a configuration, both steps 621 and 622 may additionally include, as shown in FIG. 6C, a step 621a, which provides to at least one of first UE 101 and second UE 102 a trigger message, which defines an originator and a recipient of the first SL-PDS. The originator may in some embodiments be second UE 102 and the recipient may be first UE 101. In some embodiments, the originator may be first UE 101 and the recipient may be second UE 102. It should be noted that in some embodiments, the entity triggering the exchange may not be any one of the originators and the recipient of the first SL-PDS. The configuration of the SL-PDS may also include a LOS indication, which may be used to determine the reliability of the estimation of the first distance.

Further, as shown in FIG. 6C, both steps 621 and 622 may additionally include a step 621b, which may define, either as part of the trigger message or independently, a distance estimation methodology to be used for estimating the first estimated distance. Accordingly, triggering the exchange may provide instructions identifying the distance estimation methodology to be used and which information should be provided to enable the respective distance estimation methodology. The person skilled in the art will understand that the trigger message may further include any other information required to estimate the first distance based on the chosen distance estimation methodology.

In step 630, method 600 obtains, based on a second PDS communicated between first UE 101 and a first assist node associated with communications network 100, a second estimated distance between first UE 101 and the first assist node. Similarly to the first estimated distance at step 620, the second distance may be estimated based on any distance estimation methodology enabling the estimation of a distance based on the exchange of a signal, i.e. in the case of the second estimated distance the second PDS. It should be noted that in some embodiments, the distance estimation methodology used to estimate the first distance may be the same as used for estimating the second distance. However, in some embodiments, the distance estimation methodology used to estimate the first distance may be different from the one used for the estimation of the second distance. The distance estimation method used for estimating the two distances depends on the capabilities of the communication links between the respective entities as well as the capabilities of the respective interfaces used to interface with the respective communications links. It will be apparent to the person skilled in the art that additional or other factors determining the choice of distance estimation method may be taken into account.

The first assist node may be, in some embodiments, assist UE 103. In some embodiments, the first assist node may be a node of communications network 100, such as BS 112a or BS 112b. In general, the first assist node may be any node enabling estimation of the second distance as well as a third distance, which will be discussed with regard to step 640, in order to allow for the estimation of the direction from first UE 101 to second UE 102. Accordingly, an assist node may be any node capable of exchanging a signal enabling the estimation of a distance from the assist node to first UE 101 and to second UE 102.

The second PDS refers, similar to the first SL-PDS, to any kind of signal enabling the determination of a position of the first assist node relative to the first UE 101. Different from the first SL-PDS, however, the second PDS may be transmitted via other communication channels than direct communication. The second PDS may for example be routed through communications network 100 to UE 101, e.g. via a Uu interface, such as wireless connection 114. Of course, the second PDS may, like the first SL-PDS, be exchanged via direct communication, e.g. via a second sidelink 150, if the first assist node is an assist UE, such as assist UE 103. In such cases, the second PDS may also be referred to as a second SL-PDS. It should be noted that, while the present application refers to the signal enabling the determination of a position of the first assist node relative to the first UE 101 as second PDS, this signal may also be referred to as second PRS or second RS or any other suitable expression.

Step 630 may further comprise a step 631, which triggers an exchange of the second PDS between first UE 101 and the first assist node. Step 631 corresponds to step 621 with the second PDS replacing the first SL-PDS and the first assist node replacing second UE 102. In embodiments in which the first assist node is not an assist UE, downlink control information (DCI) as well as uplink control information (UCI) take the place of SCI. To avoid repetitions, the similar parts of the description of step 621 are not repeated here. In addition, like step 621, step 631 may include steps 621a and 621b shown in FIG. 6C.

While not shown in FIG. 6A, step 630 may include a step corresponding to step 622, i.e. the second PDS may be exchanged using a broadcast transmission. If the first assist node is not an assist UE, the transmission may be made on a broadcast channel BCH. If the first assist node is an assist UE, the transmission may be made on SL-BCH.

Step 630 may further comprise a step 632, which estimates the second estimated distance based on a receive property of the second PDS exchanged between the first assist node and first UE 101. Step 632 corresponds to step 623 with the second PDS replacing the first SL-PDS and the first assist node replacing second UE 102. To avoid repetitions, the description of step 623 is not repeated here.

In step 640, method 600 obtains, based on a third PDS communicated between second UE 102 and the first assist node associated with the communications network, a third estimated distance between second UE 102 and the first assist node. Step 640 corresponds to step 630 with the third estimated distance replacing the second estimated distance and first UE 101 being replaced by second UE 102. To avoid repetitions, the similar parts of the description of step 630 are not repeated here.

It should be noted that, while the present application refers to the signal enabling the determination of a position of the first assist node relative to the second UE 102 as third PDS, this signal may also be referred to as third PRS or third RS or any other suitable expression.

Step 640 may further comprise a step 641, which triggers an exchange of the second PDS between second UE 102 and the first assist node. Step 641 corresponds to step 621 with the third PDS replacing the first SL-PDS, the first assist node replacing second UE 102 and second UE 102 replacing first UE 101. In embodiments in which the first assist node is not an assist UE, downlink control information (DCI) as well as uplink control information (UCI) take the place of SCI. To avoid repetitions, the similar parts of the description of step 621 are not repeated here.

In addition, like step 621, step 641 may include steps 621a and 621b shown in FIG. 6C. While not shown in FIG. 6A, step 640 may include a step corresponding to step 622, i.e. the third PDS may be exchanged using a broadcast transmission. If the first assist node is not an assist UE, the transmission may be made on BCH. If the first assist node is an assist UE, the transmission may be made on SL-BCH.

Step 640 may further comprise a step 642, which estimates the third estimated distance based on a receive property of the third PDS exchanged between the first assist node and second UE 102. Step 642 corresponds to step 623 with the third PDS replacing the first SL-PDS, the first assist node replacing second UE 102 and second UE 102 replacing first UE 101. To avoid repetitions, the description of step 623 is not repeated here.

Steps 620, 630 and 640 and more precisely steps 621, 631 and 641 are shown in FIG. 6A as following one another. However, while in some embodiments the exchanges of the first SL-PDS, the second PDS and the third PDS may indeed be triggered subsequently, they may also be triggered concurrently. Additionally, each trigger message may define an identical transmission timing for the first SL-PDS, the second PDS and the third PDS leading to a simultaneous or near-simultaneous transmission of the first SL-PDS, the second PDS and the third PDS. Further, each trigger message may define an identical time interval for the first SL-PDS, the second PDS and the third PDS, i.e. the three signals may be transmitted at a similar time. Defining an identical timing interval may be advantageous in case of moving UEs, such as autonomous driving units. In some embodiments, any information regarding the transmission time of the first SL-PDS, the second PDS and the third PDS may be omitted, in which case the three signals may be transmitted on the next available pre-configured time resource.

In some embodiments, steps 621, 631 and 641 may be performed by first UE 101. For example, first UE 101 may broadcast a trigger message to second UE 102 and the first assist node.

Alternatively, first UE 101 may transmit a trigger message to second UE 102 and the first assist node. In some embodiments, steps 621, 631 and 641 may be performed by a location control node of communications network 100, such as LMF 139 or another node of communications network 100, such as RAN 111. As in the case of triggering these steps by first UE 101, LMF139 or RAN 111 may broadcast a trigger message or may transmit trigger messages to first UE 101, second UE 102 and the first assist node.

Method 600 may additionally include a step 650, which obtains, based on a fourth PDS, a fourth estimated distance between first UE 101 and a second assist node, and a step 655, which obtains, based on a fifth PDS, a fifth estimated distance between second UE 102 and the second assist node. The second assist node is similar to the first assist node and may for example be an assist UE 103 or a node of communications network 100, such as BS 112a or BS 112b. While steps 650 and 655 refer to the signal enabling the determination of a position of the second assist node relative to first UE 101 as fourth PDS and to the signal enabling the determination of a position of the second assist node relative to second UE 102 as fifth PDS, these signals may also be respectively referred to as fourth and fifth PRS or fourth and fifth RS or any other suitable expression. Steps 650 and 655 correspond to steps 620, 630 and 640, the description of which is not repeated here to avoid repetitions.

In step 660, method 600 may select the first assist node from a plurality of candidate nodes. Candidate nodes may for example be other UEs with which first UE 101 can establish direct communication or may be nodes of the communications network 100, such as BS 112a and BS 112b, with which first UE 101 can establish communication via the communications network 100. In general, a candidate node may be any node suitable for assisting in estimating the direction from first UE 101 to second UE 102.

In some embodiments, step 660 may depend on a plurality of predetermined distances between the first UE 101 and each of the plurality of candidate nodes. For example, the distances of the plurality of candidate nodes may be pre-estimated, e.g. in accordance with the distance estimation methodologies discussed with reference to step 620. From these nodes, the first assist node may then be selected in some embodiments based on the shortest estimated distance.

In some embodiments, step 660 may additionally depend on a further plurality of predetermined distances between second UE 102 and each of the plurality of candidate nodes, obtained from a different distance observation than the plurality of predetermined distances. For example, the distances of the plurality of candidate nodes to the second UE 102 may be pre-estimated, e.g. in accordance with the distance estimation methodologies discussed with reference to step 620. These distances from each candidate node to second UE 102 are then compared to the respective distances from each candidate node to first UE 101. The first assist node may then be selected based on the shortest distance to first UE 101 and to second UE 102.

In addition to or instead of selecting the first assist node from a plurality of candidate nodes based on an estimated distance from first UE 101 and second UE 102 to the candidate nodes, step 660 may also select the first assist node based on further criteria. For example, in embodiments in which communications network 100 is a cellular network, the first assist node may be selected based on the cell in which it is located. In some embodiments, the list of candidate nodes may be pre-determined based on the cells in which the candidates are located to reduce the number of distance estimations necessary. In some embodiments, the first assist node may be selected based on a level of mobility of the candidate nodes. For example, the first assist node may be selected based on no or limited mobility, such as a fixed node of communications network 100, e.g. BS 112a or BS 112b, or a low-mobility UE, such as an anchor UE, a roadside unit (RSU) or a VMS. In some embodiments, the first assist node may be selected based on no or limited relative mobility, i.e. the first assist node may be an assist UE moving at a similar or the same velocity as first UE 101. The mobility level may also be used, in some embodiments, to determine the plurality of candidate nodes to reduce the number of distance estimations necessary. In some embodiments, the received signal strength may be used to select the first assist node or to pre-determine the plurality of candidate nodes. In some embodiments, the plurality of candidate nodes may be pre-determined based on an LOS indication received from each candidate node.

Step 660 may additionally select the second assist node in the same manner as the first assist node, if steps 650 and 655 of method 600 are performed. In the context of the second assist node, step 660 may also decide, based on the assist node selection criteria discussed above, that using a second assist node may be beneficial. For example, while selecting the first assist node, step 660 may determine that estimating the second and the third distance based on any one of the plurality of the candidate nodes may not be sufficiently precise. Such a determination may e.g. be based on an LOS indication from the candidate nodes, a signal strength of the candidate nodes, a mobility level of the candidate nodes and/or a predetermined positioning accuracy requirement. The person skilled in the art will understand that other or additional factors may influence this determination. In such cases, step 660 may, after having made this determination, select the second assist node and thereby trigger the performance of steps 650 and 655. Accordingly, step 660 may be performed prior to steps 650 and 655. In some embodiments, it may be determined prior to step 660 to perform steps 650 and 655. This determination may e.g. be based on the same criteria which may be used by step 660 to determine to select a second assist node discussed above. In such case, the second assist node may be used to reliably estimate the direction from first UE 101 to second UE 102. Accordingly, step 660 may select the second assist node without determining a need for the second assist node.

As discussed above, selecting the first assist node may be based on predetermined distances between at least one of first UE 101 and second UE 102 and a plurality of candidate nodes. In some embodiments, steps 620 to 655 are effectively performed concurrently, e.g. simultaneously or in a specified time interval to generate predetermined distances. Step 660 then determines whether to use all estimated distances or whether the first, second and third estimated distances are sufficient to determine the direction. More generally, method 600 may obtain various estimated distances and step 660 may determine which of these distances to take into account for the estimation of the direction in step 680. For example, method 600 may first determine a plurality of candidate nodes based on the above-discussed criteria, then obtain estimated distances between first UE 101, second UE 102 and the candidate nodes and then choose the estimated distances to be considered in step 680. In other words, step 660 may, in some embodiments, select estimated distances.

Method 600 may include a step 670, which obtains a report message indicative of at least one of the estimated first distance, the estimated second distance, or the estimated third distance. In particular, the report message may, in some embodiments, include, in addition to the respective estimated distance, at least one reporting item, the at least one reporting item optionally being specified by the trigger message defining an originator and a recipient of the respective one of the first SL-PDS or the second and third PDS.

As discussed above with regard to step 621, the trigger message may define that the first SL-PDS, the second PDS and the third PDS include any information necessary to enable the distance estimation methodology to be used to estimate the respective distance. This information may be included in the reporting item of step 670. Exemplary reporting items include, but are not limited to, at least one of one or more distance estimation parameters used to estimate the respective estimated distance, a line-of-sight indication, a recipient orientation, and a location of the recipient. In some embodiments, the one or more distance estimation parameters include at least one of a receive property of the at least one of the first SL-PDS or the second and third PDS, a received signal strength, time difference of arrival, round-trip-time, sender ID, receiver ID, angle of arrival, angle of departure, sender beam information, sender beam ID, receiver beam information and receiver beam ID.

RSRP, TDOA, an LOS indication, time measurements, e.g. based on time stamps or measured propagation delays, AoA measurement, AoD measurement, in the case of approximately static or low mobility nodes or UEs their respective location, an orientation of the recipient of the trigger message or sender beam information.

The report message may be obtained by the node performing the distance estimation. Thus, in embodiments where first UE 101 estimates the first distance and estimates the direction, step 670 constitutes an intra-node operation as far as first UE 101 and the first estimated distance are concerned. In embodiments, in which a local control node estimates the direction, such as LMF 139, the report messages may be obtained by the local control node.

Method 600 includes a step 680, which estimates the direction from the first UE to the second UE based on the first, second and third estimated distance. In other words, the direction is estimated based on the azimuth angle. Step 680 may use the three estimated distances to calculate the azimuth angle based on the following equation:

$$θ = arccos ( \frac{{d}_{2}^{2} + {d}_{1}^{2} - {d}_{3}^{2}}{2 * {d}_{1} * {d}_{2}} )$$

In the above equation, θ is the estimated angle, d₁ is the first estimated distance, d₂ is the second estimated distance and d₃ is the third estimated distance. It should be understood that this equation represents but one option to calculate estimate the direction. The person skilled in the art will understand that other ways of estimating the direction based on at least three measured distances may be used.

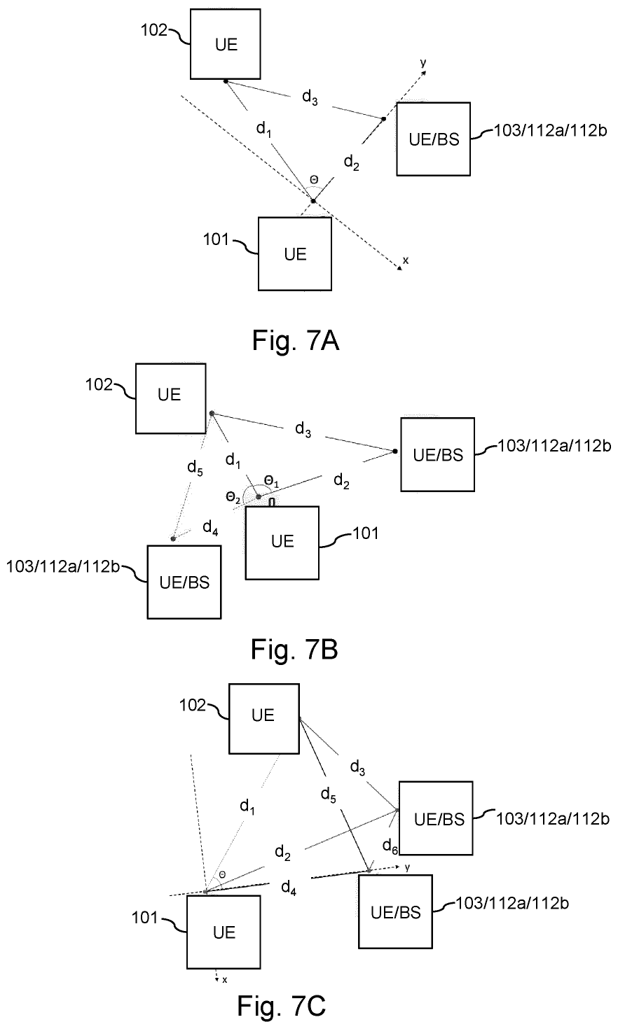

More precisely, θ represents the estimated angle between the first assist node and second UE 102 from the point of view of first UE 101. With reference to FIG. 7A, step 680 may define a two-dimensional coordinate system with first UE 101 at the center of the coordinate system and the second estimated distance as forming part of the y-axis. Step 680 may further define the x-axis of the coordinate system as intersecting the second estimated distance at 90°. Based on the accordingly defined x-axis, step 680 may determine the direction from first UE 101 to second UE 102 by subtracting 0 from 90°. Accordingly, by leveraging the ability to estimate distances between first UE 101, second UE 102 and an assist node to define a coordinate system centered on first UE 101, first UE 101 is enabled to estimate the direction from itself to second UE 102. Estimating the direction based on a coordinate system centered on first UE 101 may be especially beneficial if first UE 101 is moving. One such scenario would be if first UE 101, second UE 102 and the assist node are platooning. In such a case, any estimation of the direction based on other coordinate systems, in particular global coordinate systems or coordinate systems defined by communications network 100, may be too unreliable. Embodiments using other equations than the one defined above may e.g. use another one of the estimated distances as an axis of a coordinate system. Further, such reference coordinate systems need not be two-dimensional. For example, two of the estimated distances may be used to define two axes and the third axis is defined based on the accordingly defined two axes in order to estimate the direction from first UE 101 to second UE 102.

To further refine the estimation of the direction from first UE 101 to second UE 102, step 680 may further use the above approach to determine the elevation of second UE 102 relative to first UE 101. For example, step 680 may perform the above approach by defining a horizontal coordinate system centered on first UE 101 to estimate the direction horizontally and may further perform the above approach by defining a vertical coordinate system centered on first UE 101 to estimate the direction, I.e. the elevation, vertically.

In some embodiments, step 680 may be performed by first UE 101. In some embodiments, step 680 may be performed by a node of communications network 100, e.g. a location control node, such as LMF 139.

Finally, method 600 may include a step 690, which reports the estimated direction from first UE 101 to second UE 102. Step 690 may report the estimated direction to the node requiring the estimated direction for its functionality. For example, if first UE 101 performs step 680, first UE 101 may report the estimated distance to the process running on its control circuitry 1012 which requested the direction. If a location control node, such as LMF 139, performs step 680 and UE 101 requires the estimated distance for some of its functionality, LMF 139 report the estimated distance to UE 101.

To better understand the method of FIGS. 6A to 6C, FIGS. 7A to 7C provide examples of how the direction from first UE 101 to second UE 102 may be estimated.

FIG. 7A shows first UE 101, second UE 102 and the first assist node, which may be e.g. one of assist UE 103, BS 112a or BS 112b. Additionally, the first estimated distance, the second estimated distance and the third estimated distance obtained in steps 620, 630 and 640 are indicated by lines d₁, d₂ and d₃. The azimuth angle is indicated by θ. Since d₁, d₂ and d₃ form a triangle, the direction from first UE 101 to second UE 102 may be estimated in step 680 by performing the trigonometric function discussed above.

FIG. 7B is similar to FIG. 7A but further includes the fourth and fifth estimated distances obtained in steps 650 and 655, which are indicated by lines d₄ and d₅. Accordingly, FIG. 7B includes a second assist node, which may e.g. be one of assist UE 103, BS 112a or 112b. In this scenario, step 680 may be performed in such a way that two azimuth angles θ₁ and θ₂ are obtained. In such embodiments, the more appropriate azimuth angle may be chosen or jointly utilized based on an AoA or AoD measurement in step 623.

FIG. 7C, like FIG. 7B, includes estimated distances d₁ to d₅ and further includes a sixth estimated distance de from the first assist node to the second assist node. Based on the additional estimated sixth distance, θ may be determined based on first calculating the other two angles of the triangle formed by first UE 101, second UE 102 and the second assist node before obtaining θ based on the fact that the sum of the angles must be 180°.

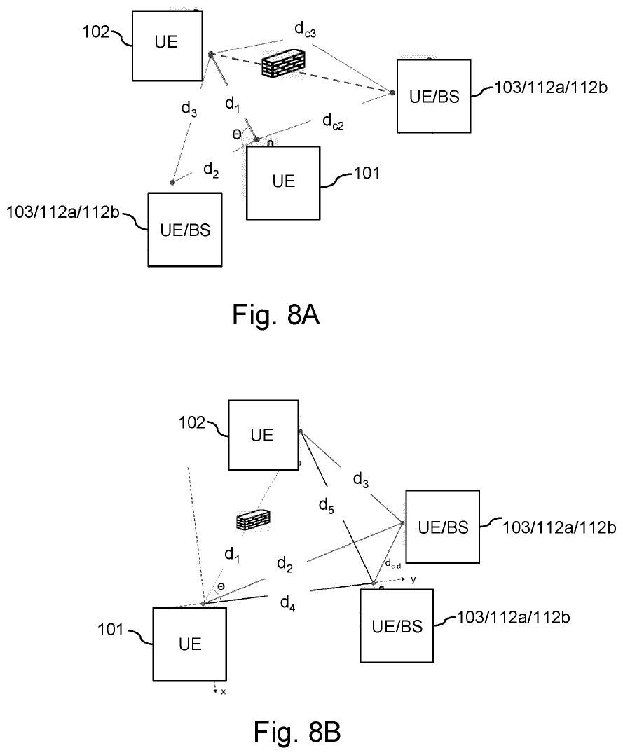

FIGS. 8A and 8B provide examples of how the method of FIGS. 6A to 6C may be used if an LOS link is not available for at least some UEs or nodes.

FIG. 8A, which corresponds to FIG. 7B, shows an example in which an LOS link is not available between second UE 102 and a candidate node. Accordingly, the candidate node and thereby candidate distances d_{c2} and d_{c3} are not selected in step 680. Instead, the only candidate node with an LOS link to both first UE 101 and second UE 102 is selected in step 680.

FIG. 8B, which correspond to FIG. 7C, illustrates an example where an LOS link is not available between first UE 101 and second UE 102. Accordingly, the method 600 determines that steps 650 and 655 should be performed to obtain fourth and fifth distances to estimate the direction based on first obtaining the other two angles in the triangle formed by first UE 101, second UE 102 and the second assist node via the triangle formed by first UE 101, the first assist node and the second assist node and the triangle formed by second UE 102, the first assist node and the second assist node.

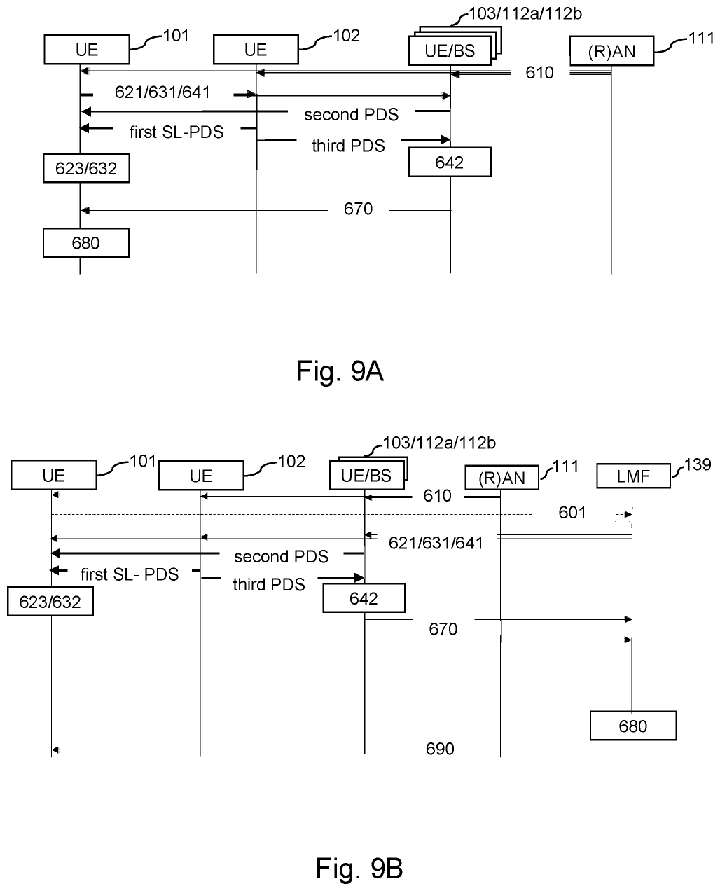

FIGS. 9A and 9B illustrate which UEs or nodes, respectively, may perform certain steps of the method of FIGS. 6A to 6C according to embodiments of the present invention.

FIG. 9A shows a signaling diagram including the first UE 101, the second UE 102, the first assist node (indicated here as assist UE 103/BS 112a/BS 112b) and RAN 111. In FIG. 9A, RAN 111 performs step 610 to provide a configuration of the first SL-PDS, the second PDS and the third PDS to first UE 101, second UE 102 and the first assist node, respectively. First UE 101 performs steps 621, 631 and 641 to trigger the exchange of the first SL-PDS, the second PDS and the third PDS. First UE 101 receives the first SL-PDS and the second PDS and accordingly performs steps 623 and 632 to estimate the first and the second distance. The assist node receives the third PDS and performs step 642 to estimate the third distance and performs step 670 to report the estimated third distance to first UE 101. First UE 101 then performs step 680 to estimate the direction.

FIG. 9B shows a signaling diagram, which, in addition to FIG. 9A, includes LMF 139. In FIG. 9B, first UE 101 performs step 601 by sending a request to estimate the direction to LMF 139. RAN 111 performs step 610 to provide a configuration of the first SL-PDS, the second PDS and the third PDS to first UE 101, second UE 102 and the first assist node, respectively. LMF 139 performs steps 621, 631 and 641 to trigger the exchange of the first SL-PDS, the second PDS and the third PDS. First UE 101 receives the first SL-PDS and the second PDS and accordingly performs steps 623 and 632 to estimate the first and the second distance. First UE 101 then performs step 670 to report the first and the second estimated distance to LMF 139. The assist node receives the third PDS and performs step 642 to estimate the third distance and performs step 670 to report the estimated third distance to LMF 139. LMF 139 then proceeds to perform step 680 to estimate the direction from first UE 101 to second UE 102. Finally, LMF 139 performs step 690 to reports the estimated direction to first UE 101.

FIGS. 9A and 9B show examples of which node or UE, respectively, may perform steps of the method 600. It should be understood, that the steps may be distributed differently over the nodes or may be performed, in part or in their entirety, by other nodes of communications network 100. In addition, while FIGS. 9A and 9B show a specific order of the steps of method 600, the order may be changed as warranted by the configuration, spatial arrangement and other factors of the respective nodes. Also, as can be seen, some steps are omitted in FIGS. 9A and 9B, indicating that not all steps of method 600 need to be performed to estimate the direction from first UE 101 to second UE 102. Some steps, such as step 690, may also be not shown because they are performed intra-node. For example, in FIG. 9A first UE 101 estimates the direction and may thus perform step 690 intra-node, as discussed above.

In addition to the above discussion of the drawings, the invention may further be illustrated by the following examples.

In one example, a method for estimating a direction from a first user equipment—UE—to a second UE, the first UE and the second UE being connectable to a communications network, may comprise the steps of: obtaining, based on a first sidelink position determination signal—SL-PDS—communicated on a sidelink of the communications network between the first UE and the second UE, a first estimated distance between the first UE and the second UE; obtaining, based on a second position determination signal-PDS-communicated between the first UE and a first assist node associated with the communications network, a second estimated distance between the first UE and the first assist node; obtaining, based on a third PDS communicated between the second UE and the first assist node, a third estimated distance between the second UE and the first assist node; and estimating, the direction from the first UE to the second UE based on the first, second and third estimated distance.

In one example, the exemplary method may further comprise configuring, at at least one of the first UE or the second UE, an SL-PDS configuration configuring the SL-PDS.

In one example, configuring of the SL-PDS configuration may comprise communicating the SL-PDS configuration from an access node of the communications network or a location control node to the at least one of the first UE or the second UE.

In one example, said configuring of the SL-PDS configuration may comprise communicating the SL-PDS configuration between the first UE and the second UE using control signaling on the sidelink.

In one example, the SL-PDS configuration may comprise at least one of: a transmission timing of the SL-PDS, a time-frequency resource allocated by the communications network to the SL-PDS, a transmit power of the SL-PDS, a beam configuration of the SL-PDS, a sequence design of the SL-PDS, at least one reporting item for reporting an exchange of the SL-PDS between the first UE and the second UE, a point in time at which the first SL-PDS is to be sent, or a time interval within which the first SL-PDS is to be sent.

In one example, the step of obtaining the first estimated distance may comprise triggering an exchange of the first SL-PDS between the second UE and the first UE on a first sidelink communication channel established between the first UE and the second UE on the sidelink of the communications network.

In one example, the step of obtaining the first estimated distance may comprise triggering an exchange of the first SL-PDS between the second UE and the first UE using a broadcast transmission of at least one of the first UE or the second UE.

In one example, the step of obtaining the first estimated distance may comprise estimating the first estimated distance based on a receive property of the first SL-PDS exchanged between the second UE and the first UE.

In one example, the receive property may comprise at least one of a received signal strength, a propagation time, an angle-of-departure or an angle-of-arrival.

In one example, the steps of obtaining the second estimated distance and the third estimated distance may comprise triggering an exchange of the second PDS between the first UE and the first assist node and triggering an exchange of the third PDS between the second UE and the first assist node.

In one example, the exchange of the second PDS between the first UE and the first assist node and the exchange of the third PDS between the second UE and the first assist node may be on the sidelink of the communications network, wherein the second and the third PDS may respectively be an SL-PDS, wherein the first assist node is a first assist UE.

In one example, the exchange of the second and third PDS may be on a second and third sidelink communication channel established on the sidelink of the communications network between the first UE and the first assist UE and the second UE and the first assist UE, respectively.

In one example, the exchange of the second and third PDS may use broadcast transmissions on the sidelink.

In one example, the steps of obtaining the second and the third estimated distances may comprise: estimating the second estimated distance based on a receive property of the second PDS exchanged between the assist node and the first UE; and estimating the third estimated distance based on a receive property of the third PDS exchanged between the second UE and the first assist node.

In one example, the method may further comprise the step of: obtaining, based on a fourth PDS, a fourth estimated distance between the first UE and a second assist node; and obtaining, based on a fifth PDS, a fifth estimated distance between the second UE and the second assist node, wherein estimating the direction from the first UE to the second UE may further be based on the fourth estimated distance and the fifth estimated distance.

In one example, the direction from the first UE to the second UE may be estimated selectively based on the second to fifth estimated distance depending on one or more trigger criteria, the one or more trigger criteria comprising at least one of: whether line-of-sight communication between the first UE and the second UE is available; a mobility level of the first UE; a mobility level of the second UE; a mobility level of the first assist node; or a predetermined positioning accuracy requirement.

In one example, the method may further comprise the step of triggering an exchange of at least one of the first SL-PDS, the second PDS or the third PDS, wherein the step of triggering includes providing, to at least one of the first UE, the second UE or the assist node, a trigger message, the trigger message defining an originator and a recipient of the at least one of the first SL-PDS or the second and third PDS.

In one example, the step of estimating the respective estimated distance may be performed by the recipient of the at least one of the first SL-PDS or the second and third PDS.

In one example, the step of triggering may further include defining a distance estimation methodology to be used for estimating the respective estimated distance.

In one example, the distance estimation methodology may be one of a one-way ranging measurement or a round-trip measurement.

In one example, the distance estimation methodology may further define the measurement type, wherein the measurement type is one of signal strength-based, angle-based or time-based.

In one example, the measurement type may be one of reference signal received power—RSRP —, time difference of arrival-TDOA or time difference between sender and receiver.

In one example, the trigger message may further define a configuration of the at least one of the first SL-PDS or the second and third PDS.

In one example, the step of triggering may be performed by one of the first UE, an access node of the communications network, and a location control node of the communications network.

In one example, the method may further comprise the step of obtaining a report message indicative of at least one of the estimated first distance, the estimated second distance, or the estimated third distance.

In one example, the report message may include the respective estimated distance and at least one reporting item, the at least one reporting item optionally being specified by a trigger message defining an originator and a recipient of the respective one of the first SL-PDS or the second and third PDS.

In one example, the at least one reporting item may include at least one of one or more distance estimation parameters used to estimate the respective estimated distance, a line-of-sight indication, a recipient orientation, and a location of the recipient.

In one example, the one or more distance estimation parameters may include at least one of a receive property of the at least one of the first SL-PDS or the second and third PDS, a received signal strength, time difference of arrival, round-trip-time, sender ID, receiver ID, angle of arrival, angle of departure, sender beam information, sender beam ID, receiver beam information and receiver beam ID.

In one example, the direction from the first UE to the second UE may be estimated based on an azimuth angle.

In one example, the azimuth angle may be calculated based on the following equation

$$θ = arccos ( \frac{{d}_{2}^{2} + {d}_{1}^{2} - {d}_{3}^{2}}{2 * {d}_{1} * {d}_{2}} )$$

wherein θ is the estimated angle, d₁ is the first estimated distance, d₂ is the second estimated distance and d₃ is the third estimated distance.

In one example, the direction may be estimated by one of the first UE and a location control node.

In one example, the method may comprise the step of selecting the first assist node from a plurality of candidate nodes.

In one example, the step of selecting the first assistant node from a plurality of candidate nodes may depend on a plurality of predetermined distances between the first UE and each of the plurality of candidate nodes.

In one example, the first assistant node may be selected based on the shortest distance amongst the plurality predetermined distances.

In one example, the step of selecting the first assistant node from a plurality of candidate nodes may further depend on a further plurality of predetermined distances between the second UE and each of the plurality of candidate nodes, obtained from a different distance observation than the plurality of predetermined distances.

In one example, the plurality of predetermined distances may be predetermined based on cells of the communications network associated with each one the plurality of candidate nodes, as well as the second UE and the first UE.

The preceding description has been provided to illustrate the estimating a direction from a first UE to a second UE while at least partially relying on direct communication between the first UE and the second UE. It should be understood that the description is in no way meant to limit the scope of the invention to the precise embodiments discussed throughout the description. Rather, the person skilled in the art will be aware that these embodiments may be combined, modified or condensed without departing from the scope of the invention as defined by the following claims.

1. A method for estimating a direction from a first user equipment (UE) to a second UE, the first UE and the second UE being connectable to a communications network, the method comprising the steps of:
obtaining, based on a first sidelink position determination signal (SL-PDS) communicated on a sidelink of the communications network between the first UE and the second UE, a first estimated distance between the first UE and the second UE;
obtaining, based on a second position determination signal (PDS) communicated between the first UE and a first assist node associated with the communications network, a second estimated distance between the first UE and the first assist node;
obtaining, based on a third PDS communicated between the second UE and the first assist node, a third estimated distance between the second UE and the first assist node; and
estimating, the direction from the first UE to the second UE based on the first, second and third estimated distance.

2. The method of claim 1, wherein the method further comprises:
configuring, at at least one of the first UE or the second UE, an SL-PDS configuration configuring the SL-PDS.

3. The method of claim 2, wherein the SL-PDS configuration comprises at least one of:
a transmission timing of the SL-PDS,
a time-frequency resource allocated by the communications network to the SL-PDS,
a transmit power of the SL-PDS,
a beam configuration of the SL-PDS,
a sequence design of the SL-PDS,
at least one reporting item for reporting an exchange of the SL-PDS between the first UE and the second UE,
a point in time at which the first SL-PDS is to be sent, or
a time interval within which the first SL-PDS is to be sent.

4. The method of claim 1, wherein the step of obtaining the first estimated distance comprises:
triggering an exchange of the first SL-PDS between the second UE and the first UE on a first sidelink communication channel established between the first UE and the second UE on the sidelink of the communications network.

5. The method of claim 1, wherein the step of obtaining the first estimated distance comprises:
triggering an exchange of the first SL-PDS between the second UE and the first UE using a broadcast transmission of at least one of the first UE or the second UE.

6. The method of claim 1, wherein the step of obtaining the first estimated distance comprises:
estimating the first estimated distance based on a receive property of the first SL-PDS exchanged between the second UE and the first UE.

7. The method of claim 6,
wherein the receive property comprises at least one of a received signal strength, a propagation time, an angle-of-departure or an angle-of-arrival.

8. The method of claim 1, wherein the steps of obtaining the second estimated distance and the third estimated distance comprise:
triggering an exchange of the second PDS between the first UE and the first assist node and triggering an exchange of the third PDS between the second UE and the first assist node.

9. The method of claim 8,
wherein the exchange of the second PDS between the first UE and the first assist node and the exchange of the third PDS between the second UE and the first assist node is on the sidelink of the communications network,
wherein the second and the third PDS are respectively an SL-PDS;
wherein the first assist node is a first assist UE.

10. The method of claim 9,
wherein the exchange of the second and third PDS;
is on a second and third sidelink communication channel established on the sidelink of the communications network between the first UE and the first assist UE and the second UE and the first assist UE, respectively; or
uses broadcast transmissions on the sidelink.

11. The method of claim 1, wherein the steps of obtaining the second and the third estimated distances comprise:
estimating the second estimated distance based on a receive property of the second PDS exchanged between the assist node and the first UE; and
estimating the third estimated distance based on a receive property of the third PDS
exchanged between the second UE and the first assist node.

12. The method of claim 1, further comprising the step of:
obtaining, based on a fourth PDS, a fourth estimated distance between the first UE and a second assist node; and
obtaining, based on a fifth PDS, a fifth estimated distance between the second UE and the second assist node,
wherein estimating the direction from the first UE to the second UE is further based on the fourth estimated distance and the fifth estimated distance.

13. The method of claim 12, wherein the direction from the first UE to the second UE is estimated selectively based on the second to fifth estimated distance depending on one or more trigger criteria, the one or more trigger criteria comprising at least one of: whether line-of-sight communication between the first UE and the second UE is available; a mobility level of the first UE; a mobility level of the second UE; a mobility level of the first assist node; or a predetermined positioning accuracy requirement.

14. The method of claim 1, further comprising the step of triggering an exchange of at least one of the first SL-PDS, the second PDS or the third PDS, wherein the step of triggering includes providing, to at least one of the first UE, the second UE or the assist node, a trigger message, the trigger message defining an originator and a recipient of the at least one of the first SL-PDS or the second and third PDS.

15. The method of claim 14, wherein the step of estimating the respective estimated distance is performed by the recipient of the at least one of the first SL-PDS or the second and third PDS.

16. The method of claim 14, wherein the step of triggering further includes defining a distance estimation methodology to be used for estimating the respective estimated distance.

17. The method of claim 16, wherein the distance estimation methodology is one of a one-way ranging measurement or a round-trip measurement.

18. The method of claim 16, wherein the distance estimation methodology further defines the measurement type, wherein the measurement type is one of signal strength-based, angle-based or time-based.

19. The method of claim 14, wherein the trigger message further defines a configuration of the at least one of the first SL-PDS or the second and third PDS.

20. The method of claim 14, wherein the step of triggering is performed by one of the first UE, an access node of the communications network, and a location control node of the communications network.

21-29. (canceled)
